(19) United States
(12) Patent Application Publication
(10) Pub. No.: US 2026/0006402 A1
(43) Pub. Date: Jan. 1, 2026

(54) ENHANCED GEOFENCING

(71) Applicant: iSharingSoft, Inc., Irvine, CA (US)

(72) Inventors: Yongjae Chuh, Irvine, CA (US); Seyeong Bae, Gyeonggi-do (KR); Hae Kyung Cho, Irvine, CA (US)

(21) Appl. No.: 18/756,516

(22) Filed: Jun. 27, 2024

(51) Int. Cl. H04W 4/021; H04W 4/029

(52) U.S. Cl. CPC H04W 4/021; H04W 4/029

(57) ABSTRACT

Methods and systems include detecting first entry of a user device into a first geofencing region. A first action is performed responsive to the first entry. Second entry of the user device is detected into a second geofencing region that is adjacent to the first geofencing region, after detecting the first entry. A second action is performed responsive to the second entry.

### BACKGROUND OF THE INVENTION

The present invention relates to location tracking, and, more particularly, to geofencing.

Many devices come equipped with location-tracking capabilities, such as global positioning satellite (GPS) receivers. These devices can locate their position with a high degree of precision. This, combined with the ubiquity of wireless data transmission capabilities, makes it possible for devices to provide real-time location information, making it possible to track these devices as they move.

However, performing frequent location updates with GPS can be unnecessarily demanding on a device's battery power. Geofencing uses other information to determine when the device enters or leaves a predetermined area, for example generating a notification or alert that location-based services on the device can use.

### BRIEF SUMMARY OF THE INVENTION

A method includes detecting first entry of a user device into a first geofencing region. A first action is performed responsive to the first entry. Second entry of the user device is detected into a second geofencing region that is adjacent to the first geofencing region, after detecting the first entry. A second action is performed responsive to the second entry.

A system includes a hardware processor and a memory that stores a computer program. When executed by the hardware processor, the computer program causes the hardware processor to detect first entry of a user device into a first geofencing region, to perform a first action responsive to the first entry, to detect second entry of the user device into a second geofencing region that is adjacent to the first geofencing region, after detecting the first entry, and to perform a second action responsive to the second entry.

These and other features and advantages will become apparent from the following detailed description of illustrative embodiments thereof, which is to be read in connection with the accompanying drawings.

### BRIEF DESCRIPTION OF THE DRAWINGS

The disclosure will provide details in the following description of preferred embodiments with reference to the following figures wherein:

FIG. 1 is a diagram of a geofencing scenario, with a user's path passing through a predetermined geofencing region, but with the exit message being delayed after the user leaves the geofencing region, in accordance with an embodiment of the present invention;

FIG. 2 is a diagram of a geofencing arrangement with a primary geofencing region and a set of secondary geofencing regions that make it possible to improve detection of a user's exit from the primary geofencing region, in accordance with an embodiment of the present invention;

FIG. 3 is a diagram of a geofencing arrangement with a primary geofencing region and a set of secondary geofencing regions, where the secondary geofencing regions have differing radii, in accordance with an embodiment of the present invention;

FIG. 4 is a block/flow diagram of an enhanced geofencing process that uses entry into a secondary geofencing region to trigger an action, in accordance with an embodiment of the present invention; and

FIG. 5 is a block diagram of a user device that can perform enhanced geofencing, in accordance with an embodiment of the present invention.

### DETAILED DESCRIPTION

Geofencing may use a variety of inputs to detect when a user's device enter or exits a predetermined area. This can help to reduce the reliance on global positioning satellite (GPS) measurements, as making frequent GPS measurements can deplete a device's battery power. However, while geofencing systems are intended to provide rapid alerts when a user's device exists the predetermined area, some systems delay exit alerts, for example with an average detection delay of 100 meters. For a geofence area with a 25 meter radius, this can result in tracking gaps of 75 meters or more.

Enhanced geofencing results can nonetheless be obtained from such systems by using additional geofencing regions around an area of interest. Whereas exit signals may be delayed, signals from a user device entering a geofence area are relatively prompt. The additional geofencing regions may be determined in a pattern that surrounds the area of interest. When a user enters any of these additional areas, motion tracking may be enabled as it is clear that the user has left the area of interest. This significantly reduces the average detection distance needed to determine that a user has begun moving from a stationary state.

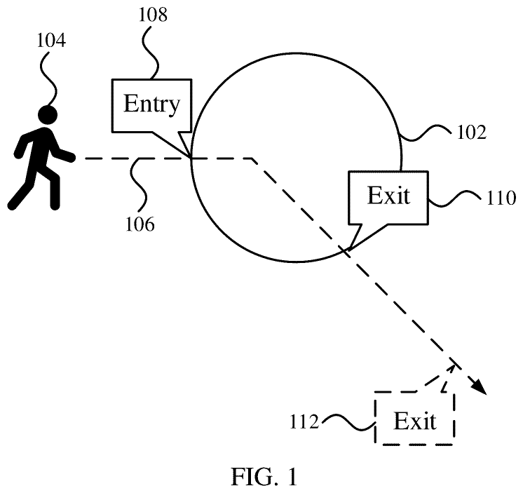

Referring now to FIG. 1, an exemplary geofencing scenario is shown. A user 104 enters a predetermined geofencing region 102. The user 104 may carry a mobile device, such as a smartphone, wearable device, or any other appropriate device having location services. The predetermined geofencing region 102 may be centered on any appropriate location and may have any appropriate radius. For example, the geofencing region 102 may be centered on a user's home or workplace, or may instead be centered on a location of interest, such as a store, movie theater, or public attraction.

As the user 104 moves through space, the device tracks the user's location using any appropriate mechanism, such as GPS measurements. These measurements provide a high-resolution position for the user 104 and may be used to enable any appropriate location-based service. To achieve this high precision, the measurements may be performed frequently, for example multiple times per second when the user 104 is in a vehicle or otherwise moving at a high rate of speed. These measurements may cause the device to consume battery power at a higher rate than if the location-based service were turned off.

Examples of location-based services include navigation, location tracking, and mapping, but may also be used for asset management and security, as the locations of valuable items may be tracked using a tag or device attached to the item. In some cases the location-based service may trigger other applications or services on the user's device, for example causing the device to trigger smart home features responsive to the user entering or leaving their home.

The user 104 may move along a path 106 that enters the predetermined geofencing region 102. When the user's device detects that it has entered the predetermined geofencing region 102, it issues an entry message 108, which may include any appropriate notification, alert, system event, or other message. The entry message 108 may trigger the user's device to halt its frequent GPS-based location updates. The specific mechanism for this entry message 108 and the location services will depend on the software and hardware of the user's device. For example, on an iOS® device, the entry message 108 may cause the device to turn off the CLLocationManager service to save battery power.

While in the predetermined geofencing region 102, the user's location may be updated using lower-precision services, such as using WIFI®-based location sensing, cell tower-based location sensing, or low-power GPS (e.g., using less frequent updates). These lower-precision services may not be able to determine the user's location with as high a degree of precision as frequent GPS measurements can. This state may persist until the user 104 leaves the predetermined geofencing region 102, at which point an exit message 110 is generated. The exit message 110 may reenable high-precision location tracking, for example by reenabling CLLocationManager.

The predetermined geofencing region 102 may have any appropriate radius, such as 25 meters, which may be selected to correspond to a user's expected motions within a given geographic area. For example, 25 meters may be appropriate for a domicile or workplace, but may be insufficient in a department store. While the exit message 110 is supposed to be triggered promptly when the user's path 106 leaves the predetermined geofencing region 102, a delayed exit message 112 may instead be triggered substantially after the user 104 has left the predetermined geofencing region 102. This may occur due to delays within the user device's operating system, resulting in a lack of accuracy for location-based services, as the high-precision location tracking may not be turned back on until the user has traveled a significant distance from the predetermined geofencing region. This is of particular concern for location tracking services, where the user's location may not be accurately tracked in the time between their departure from the geofencing region 102 and the time when the delayed exit message 112 is issued.

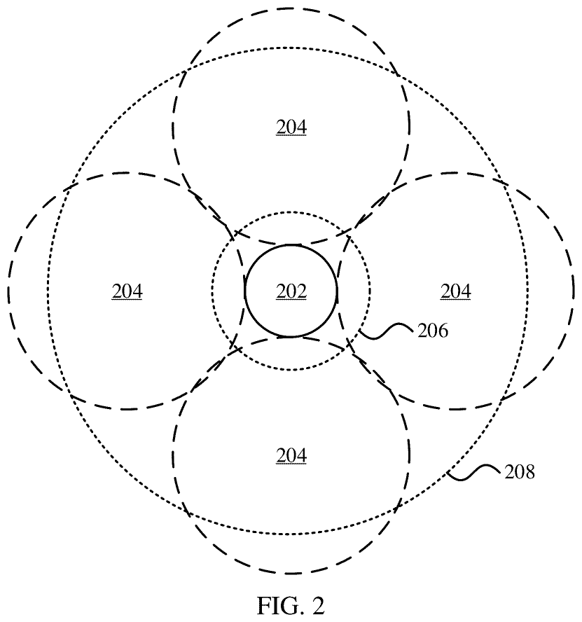

Referring now to FIG. 2, an enhanced geofencing layout is shown. A primary geofencing region 202 is shown with a first radius. Secondary geofencing regions 204 are arrayed around the primary geofencing region 202, each having a second radius that is greater than the first radius. For example, the second radius may be three times greater than the first radius, to provide adequate coverage.

A first perimeter 206 and second perimeter 208 are shown, being centered around the primary geofencing region 202. The first perimeter 206 shows an average distance from the primary geofencing region 202 at which a user's path 106 will trigger an entry message 108 at one of the secondary geofencing regions 204 after leaving the primary geofencing region 202. The second perimeter 208 shows the distance from the primary geofencing region 202 at which a delayed exit message 112 from the primary geofencing region 202 may be triggered. Because entry messages 108 may be issued relatively promptly, even when exit messages 112 are delayed, these entry messages 108 associated with the secondary geofencing regions 204 may be used instead of the delayed exit message 112 to trigger a switch back to high-precision location tracking.

The number and radius of secondary geofencing regions 204 may be selected to fully encircle the primary geofencing region 202, with greater numbers of secondary geofencing regions 204 having smaller radii providing a closer first perimeter 206. Additionally, although the secondary geofencing regions 204 are shown as being of equal size and as being equally spaced around the primary geofencing region 202, it should be understood that the secondary geofencing regions 204 may vary in size and position. Furthermore, it is specifically contemplated that the secondary geofencing regions 204 may be adjacent to the primary geofencing region 202 without overlap. However, some embodiments may have overlap between the primary geofencing region 202 and the secondary geofencing regions 204, and in some embodiments there may be a gap between the primary geofencing region 202 and the closest points of the secondary geofencing regions 204.

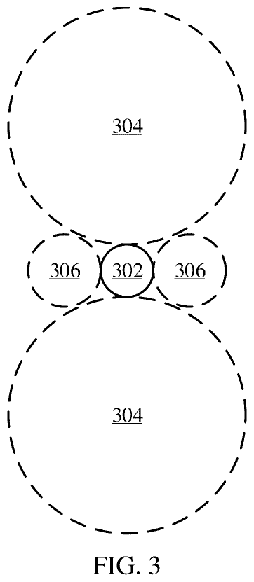

Referring now to FIG. 3, an enhanced geofencing layout it shown. In this view, there are relatively large secondary geofencing regions 304 and relatively small secondary geofencing regions 306 positioned around the primary geofencing region 302. This arrangement provides a relatively flat, close perimeter between the relatively large secondary geofencing regions 304 and the primary geofencing region, while there is more uncertainty between the relatively small secondary geofencing regions 306 and the primary geofencing region. This arrangement may be used to improve precision in particular directions, so that travel from the primary geofencing region 302 to the relatively large secondary geofencing regions 304 is likely to trigger a prompt entry message 108.

It should be understood that other arrangements of secondary geofencing regions are also possible, including secondary geofencing regions that have a polygonal or irregular shape, secondary geofencing regions that incompletely encompass the primary geofencing region, and secondary geofencing regions that overlap with one another. In a minimal arrangement, a single secondary geofencing arrangement may be used, for example if it is known that the location of the primary geofencing region has only a single entry and exit point. In some cases the secondary geofencing regions may include a set of regions that all have different sizes and/or shapes.

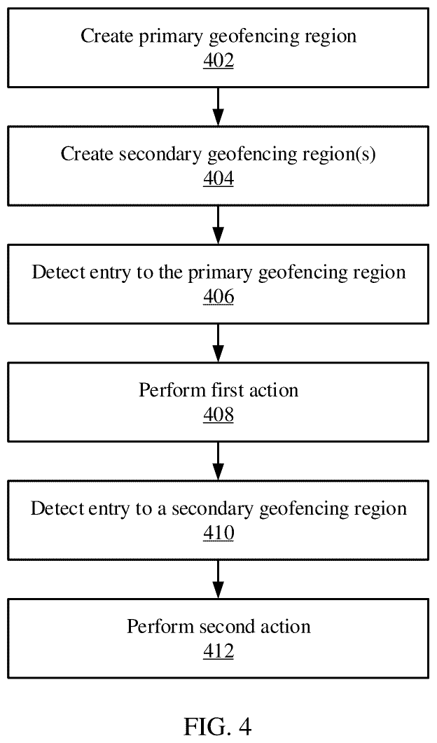

Referring now to FIG. 4, a geofencing method is shown. Block 402 creates a primary geofencing region in a predetermined geographic region, having a predetermined center point and a predetermined radius. Block 404 creates one or more secondary geofencing regions around the primary geofencing region. As noted above, the secondary geofencing region(s) may have any appropriate relationship to the primary geofencing region, with some embodiments completely encircling the primary geofencing region with secondary geofencing regions.

Block 406 detects entry of a user's device into the primary geofencing region. Viewed at a low level, this detection may be the result of detecting that the user's location as moved into the primary geofencing region using a relatively high-precision location measurement system. Viewed at a high level, this detection may be the result of receiving an entry message 108 from the operating system or geofencing service of the user's device.

Responsive to entry of the user's device into the primary geofencing region, block 408 performs a first action. It is specifically contemplated that the first action may include disabling a high-precision location measurement system and instead using a relatively low-precision location measurement system. For example, the high-precision location measurement system may include GPS measurements at a first rate, while the low-precision location measurement system may include one or more of WIFI®-based location determination, cell tower-based location determination, and GPS measurements at a second, lower rate.

Although creation of the secondary geofencing region(s) in block 404 is shown as being performed before detecting entry to the primary geofencing region in block 406, it should be understood that the secondary geofencing region(s) may instead be created responsive to the detection in block 406. This may prevent spurious entry messages as the user 104 passes through areas that will be covered by secondary geofencing regions 204 on their way to the primary geofencing region 202.

Block 410 then detects entry of the user's device into a secondary geofencing region, for example by receiving a respective entry message 108 or by detecting the user's location using the relatively low-precision location measurement system. Responsive to entry of the user's device into the secondary geofencing region, block 412 performs a second action. It is specifically contemplated that the second action may include reenabling the relatively high-precision location measurement system.

In some cases the second action in block 412 may be made responsive to either the entry message 108 of the secondary geofencing region or an exit message from the primary geofencing region, depending on which one arrives first. This may occur when an exit message is sent promptly upon leaving the primary geofencing region or when the user spends time in a gap between the primary geofencing region and a secondary geofencing region, allowing a delayed exit message time to come through before the entry message for the secondary geofencing region.

Although it is specifically contemplated that the first and section actions may relate to the status of location measurement systems, these actions may instead relate to any location-based service. For example, if the primary geofencing region is a person's home, the first action may include unlocking a door or turning lights on, while the second action may include locking the door or turning lights off. In the context of a location tracking service, the second action may reenable tracking of the user's location after they depart from a fixed location.

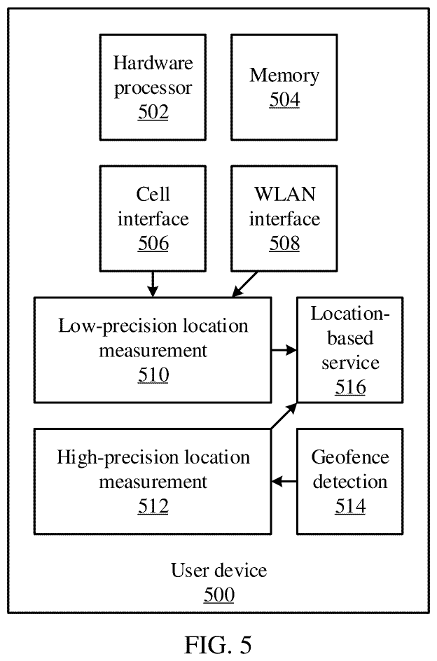

Referring now to FIG. 5, a user device 500 is shown. The user device 500 may be carried by user 104 into and out of a geofencing region 102. The user device 500 may include certain hardware and software components that may respond to entry to and exit from the geofencing region 102.

The user device 500 may include a hardware processor 502 and a memory 504. In some embodiments, the memory 504 may store software to implement various functions of the user device 500. The user device 500 may further include one or more communications interfaces, such as a cell interface 506 and a wireless local area network (WLAN) interface 508.

The user device 500 may include location measurement systems, including low-precision location measurement 510 and high-precision location measurement 512. The location measurement systems may receive location information from other devices/systems on the user device 500, such as from the cell interface 506 and the WLAN interface 508. The high-precision location measurement 512 may further include dedicated location hardware, such as a GPS receiver. The low-precision location measurement 510 and high-precision location measurement 512 provide location information to a location-based service 516, such as position tracking.

Geofence detection 514 sets geofences and, in coordination with location measurements from the low-precision location measurement 510 and/or high-precision location measurement 512, may issue entry messages 108 and exit messages 110. Based on these messages, the geofence detection 514 may issue commands to the high-precision location measurement 512 and the location-based service 516. For example, the geofence detection 514 may disable the high-precision location measurement 512 responsive to an entry message 108 for a primary geofencing region 202 and may reenable the high-precision location measurement 512 responsive to an entry message 108 for an associated secondary geofencing region 204.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The present embodiments may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software, or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

1. A computer-implemented method, comprising:
detecting first entry of a user device into a first geofencing region;
performing a first action responsive to the first entry;
detecting second entry of the user device into a second geofencing region that is adjacent to the first geofencing region, after detecting the first entry; and
performing a second action responsive to the second entry.

2. The method of claim 1, further comprising creating a set of secondary geofencing regions, including the second geofencing region, that are adjacent to the first geofencing region and that fully encircle the first geofencing region.

3. The method of claim 2, wherein creating the set of secondary geofencing regions is performed after detecting the first entry.

4. The method of claim 2, wherein the secondary geofencing regions have a radius that is greater than a radius of the first geofencing region.

5. The method of claim 2, wherein the secondary geofencing regions all have a same radius.

6. The method of claim 2, wherein the secondary geofencing regions have differing radii.

7. The method of claim 2, wherein the first action includes disabling a first location measurement system and the second action includes reenabling the first location measurement system.

8. The method of claim 7, wherein the first location measurement system includes GPS location measurement.

9. The method of claim 7, wherein detecting the second entry is performed using a second location measurement system that has a lower precision than the first location measurement system.

10. The method of claim 1, wherein performing the second action is performed without waiting for detection of exit of the user device from the first geofencing region.

11. A computer program product, the computer program product comprising a computer readable storage medium having program instructions embodied therewith, the program instructions being executable by a hardware processor to cause the hardware processor to:
detect first entry of a user device into a first geofencing region;
perform a first action responsive to the first entry;
detect second entry of the user device into a second geofencing region that is adjacent to the first geofencing region, after detecting the first entry; and
perform a second action responsive to the second entry.

12. A system, comprising:
a hardware processor; and
a memory that stores a computer program which, when executed by the hardware processor, causes the hardware processor to:
detect first entry of a user device into a first geofencing region;
perform a first action responsive to the first entry;
detect second entry of the user device into a second geofencing region that is adjacent to the first geofencing region, after detecting the first entry; and
perform a second action responsive to the second entry.

13. The system of claim 12, wherein the computer program further causes the hardware processor to create a set of secondary geofencing regions, including the second geofencing region, that are adjacent to the first geofencing region and that fully encircle the first geofencing region.

14. The system of claim 13, wherein the computer program further causes the hardware processor to create the set of secondary geofencing regions after detection of the first entry.

15. The system of claim 13, wherein the secondary geofencing regions have a radius that is greater than a radius of the first geofencing region.

16. The system of claim 13, wherein the secondary geofencing regions all have a same radius.

17. The system of claim 13, wherein the secondary geofencing regions have differing radii.

18. The system of claim 13, further comprising a first location measurement system, wherein the first action includes disabling the first location measurement system and the second action includes reenabling the first location measurement system.

19. The system of claim 18, wherein the first location measurement system includes a GPS receiver.

20. The system of claim 18, further comprising a second location measurement system that has a lower precision than the first location measurement system, wherein the computer program further causes the hardware processor to detect the second entry using the second location measurement system.
